(19) United States
(12) Patent Application Publication
(10) Pub. No.: US 2005/0197155 A1
(43) Pub. Date: Sep. 8, 2005

(54) Apparatus and system to provide wireless data services through a wireless access integrated node

(76) Inventors: John Baker, Southlake, TX (US); David K. Hui, Fremont, CA (US); Martin W. Greenwood, Bedford (GB); Antti Linden, Colleyville, TX (US); Yong Zhou, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/122,480

(22) Filed: May 4, 2005

Related U.S. Application Data
(62) Division of application No. 09/851,681, filed on May 8, 2001.
(60) Provisional application No. 60/203,421, filed on May 10, 2000.

(51) Int. Cl. H04B 7/00

(52) U.S. Cl. 455/552.1; 455/550.1

(57) ABSTRACT

An apparatus and system for providing wireless access to packet data networks and value-added services is disclosed. The wireless access integrated node (WAIN) offers a simplified internal architecture which eliminates unnecessary intermediate protocols contained in a multi-node hierarchical network architecture while still supporting the main functions of standard mobile networks and preserving standard external interfaces. The WAIN is essentially an integrated network element that provides local radio coverage and complements the capability of the public wireless network. The WAIN can automatically configure itself to minimize interference and achieve optimal performance.

### CROSS-REFERENCE TO RELATED APPLICATION

This application claims priority from U.S. provisional application No. 60/203,421, filed May 10, 2000.

### FIELD OF THE INVENTION

This invention is related to mobile data transmission systems and wireless access to packet data networks and value-added services.

### BACKGROUND OF THE INVENTION

Several digital cellular and personal communications systems have been developed to provide mobile communication and computing services. These communications standards mainly differ in radio access technologies and signaling mechanisms. The Global System for Mobile communications (GSM) was designed as a Time Division Multiple Access (TDMA) standard that also supports frequency hopping (FH). In North America, a TDMA-based standard TIA/EIA-136 and a Code Division Multiple Access (CDMA)-based standard TIA/EIA-95 standard were developed. A TDMA-based standard called Personal Digital Cellular (PDC) was developed and deployed in Japan.

Current wireless technologies are primarily circuit-switched, meaning a dedicated connection throughout the network is provided for routing the voice or data stream to its destination. Circuit-switched data networks require a dedicated channel even when no data is being sent. Market expectations for Third Generation (3G) mobile communication systems show an increasing demand for a wide range of services including voice, low and high data rate services, and wireless multimedia. The rapid growth of the Internet and mobile data services has stimulated the development of a more efficient high speed wireless packet data network which does not require a dedicated connection. Several 3G mobile communications standards, which have introduced packet radio technologies to support packet-switched mobile services, have evolved from current mobile standards.

The General Packet Radio Service (GPRS) is a packet radio system in which data is sent over the air in packets and routed independently to the desired destination. GPRS overlays a packet-based air interface on existing circuit-switched networks (either GSM or the TIA/EIA-146 TDMA systems). Multiple mobile users may share the same radio resources concurrently; these resources may be dynamically allocated upon request for packet data transmission. GPRS uses the standard Internet Protocol (IP) to send messages. The maximum data rate for GPRS is about 115 kbps. When enhanced with the Enhanced Data rate for GSM Evolution (EDGE) radio technology, GPRS will support data rates of 384 kbps or higher.

Other wireless packet data standards have been developed. The Cellular Digital Packet Data (CDPD) supports lower data rates than GPRS. For CDMA standards, TIA/EIA-95-B is the packet revision of the Direct Sequence CDMA (DS-CDMA) standard IS-95A. The maximum data rate for TIA/EIA-95-B is 86 kbps. A 3G standard, cdma2000, which is based on TIA/EIA-95-B, supports data rates up to 2 mbps. The Wideband CDMA (W-CDMA) access technology and the evolved GSM core network architecture form the basis for another 3G standard, Universal Mobile Telecommunications System (UMTS) which supports data rates up to 2 mbps.

As noted above, these new standards are based on second-generation mobile systems. Therefore, 3G mobile networks employ the same hierarchical network architecture that exists in current systems. In a typical mobile network, a Mobile Station (MS) communicates with a Base Station (BS), responsible for radio transmission and reception, in a radio coverage area, or cell. In a GSM mobile network, the BS is called a Base Transceiver Station (BTS). One or more BSs can be controlled by a Base Station Controller (BSC), which is responsible for allocating the radio resource. In some mobile systems, the BS and BSC are combined in the same node. One or more BSCs (or combined BS/BSCs) can be connected to a Mobile Switch for either circuit or packet switching. The Mobile Switch is also responsible for mobility management of the MSs attached to the network. Several Mobile Switches may be connected to a Gateway or Interworking Function (IWF), which interworks with the fixed networks. The fixed network can be a Public Switched Telephone Network (PSTN) supporting voice and other circuit-switched services, or a Packet Data Network (PDN) supporting packet data services. A database to store the MSs subscription and operational data is also required.

In a multi-node wireless network architecture, each network node deals with different functions and communicates with other nodes through a defined interface. Data transferred from an MS to a fixed network travels through several interfaces that, as the system is upgraded, need to be developed and upgraded on both sides of the interface. This sometimes requires significant development and interface integration. In addition, the complex system architecture of a multi-node wireless network can result in slowing down the transmission of information. This creates particular problems for delay-sensitive applications such as Voice over IP.

Complex network hierarchy makes interoperation between different mobile networks even more difficult. In addition, the multi-node mobile network hierarchy using a centralized switching fabric is quite different from the flat router-based Internet architecture. As the demand for wireless Internet access grows substantially, a natural bridging of these two types of network architecture becomes imminent. In fact, the All-IP network interface has been viewed as an important element of Fourth Generation wireless systems.

One of the key 3G requirements is the support of high data rate wireless multimedia services. However, the high bit rates may restrict a user's mobility due to the increasing interference in signals associated with the mobile's high mobility. In addition, with many users competing for the same radio and network resources, support of high bit rate multimedia services is limited.

In addition to multimedia services, 3G mobile communications should be able to provide personal services to anybody, anywhere, at any time. Provision of ubiquitous service requires universal access to wireless networks when the user is in different environments (indoors, outdoors, urban, rural, etc.). Wireless operators have been trying to expand their networks to improve radio coverage and capacity. Unfortunately, due to radio performance, the radio reception from the public mobile network at certain locations, such as an indoor environment, is very poor or even impossible. With the additional limitations of the complexity and cost involved in extending the hierarchical network infrastructure, the currently proposed architecture for 3G wireless networks will not provide ubiquitous service as originally envisioned. In fact, many under-served areas are not likely to get better coverage unless there is a fundamental change in mobile network architecture and network deployment strategy.

U.S. Pat. No. 6,219,346 discloses a packet switching cellular system where mobile units send information in packet format to a base station which routes the packets to switching agents identified by the packets. The switching agents forward the information to a wired network which may be a circuit switched network. Here, the switching agent is the interface between the packet switched portion of the system and the wired network.

U.S. Pat. Nos. 6,212,395 and 5,999,813 disclose a cellular private branch exchange. The cellular private branch exchange includes a base station subsystem for communicating with mobile stations. The base station subsystem is coupled with a cellular private branch exchange unit which includes a private mobile-services switching center for providing mobility management for the mobile stations. A database connected to the mobile-services switching center stores subscriber information. The cellular branch exchange can facilitate calls to subscribers without accessing the public network; however, the cellular private branch exchange unit can also connect with the public network to facilitate the exchange of information outside the cellular private branch exchange.

None of the prior art discloses a wireless access system with a simplified network architecture that supports the main functions of standard mobile networks.

It is an object of this invention to provide a wireless access system with a simplified network architecture that supports the functions of standard mobile networks.

It is an object of this invention to allow mobile users to access a packet data network through a local wireless access system and the local packet data network connection.

It is an object of this invention to off-load congested traffic from public mobile networks.

It is an object of this invention to provide universal access to wireless networks.

It is an object of this invention to support high data rate wireless multimedia services.

It is an object of this invention to provide a wireless access system that can automatically configure itself to provide optimal service.

It is an object of this invention to provide a wireless access system that can support roaming between similar network nodes.

It is an object of this invention to provide a wireless access system that can support roaming between the system's network node and public networks.

It is an object of this invention to improve the efficiency of radio resource usage and increase the overall wireless system capacity in a region.

### SUMMARY OF THE INVENTION

This invention describes a Wireless Access Integrated Node (WAIN) to improve access to and provision of wireless data services. Current mobile networks employ a multi-node hierarchical network architecture in which each network node deals with different functions and communicates with other nodes via a defined interface. The WAIN system combines the Access Network and the Core Network elements of a standard mobile data network and eliminates unnecessary intermediate network interfaces and protocol stacks that are included in the standard mobile infrastructure. The WAIN supports the necessary functions of the BS/BSC, Mobile Switch, and Gateway/IWF, including dynamic radio resource management, mobility management and security, data transfer and routing, Quality of Service support, etc. Although the internal architecture is simplified, standard external interfaces are provided. By eliminating unnecessary intermediate protocols, the WAIN system improves the speed of service, simplifies development and integration efforts, and reduces the cost of accessing and providing wireless services.

The WAIN can be owned and operated by a municipality, business, or home owner. Data packets from a mobile terminal in the WAIN environment will be routed through the WAIN system and the local data connection to the PDN. No radio and network resources from the public mobile network are used. Areas that are larger than one WAIN system's coverage or require more capacity than one system can use a number of WAIN system installed as a cluster to provide services in a confined area. The WAIN can therefore provide some users wireless data access in areas where it might not be available from the public mobile data networks due to scarce radio and network resources available in public wireless networks.

The WAIN can also provide customized, value-added services to its subscribers. These include a local information system and an appliance control system that are connected to the WAIN.

WAIN is compatible with standard mobile data networks. Therefore, the same mobile terminal used to obtain wireless data access in the WAIN environment can be used in the public mobile data networks. The WAIN also supports roaming between the WAIN environment and the public mobile networks as well as roaming between WAIN systems.

The WAIN system is essentially an integrated network element providing local radio coverage and complementing the capability of the public wireless network. The distributed radio coverage provided by the WAIN improves the efficiency of the radio resource usage and therefore increases the overall wireless system capacity in a region.

The WAIN system can automatically configure itself to minimize interference and achieve optimal performance. Since the WAIN system operates in a local environment within a small coverage area, the transmission power can be adjusted very low, which minimizes the interference level and reduces power consumption of the handset battery. The distributed WAIN systems with distinct system parameters create many tiny cells, operating with minimal signal interference, overlaid on larger cells covered by a public mobile network.

### BRIEF DESCRIPTION OF DRAWINGS

FIG. 1a is a diagram of a generic mobile network in accordance with the prior art.

FIG. 1b is a diagram of a GPRS mobile system in accordance with the prior art.

FIG. 2 is a diagram showing the protocol structure of a mobile data network in accordance with the prior art.

FIG. 3 is a diagram showing wireless internet access in a mobile data network in accordance with the prior art and wireless internet access through a WAIN system in accordance with the invention.

FIG. 4 is a diagram showing the protocol system of a WAIN system in accordance with the invention.

FIG. 5 is a block diagram showing IP data transfer through a WAIN system in accordance with the invention.

FIG. 6 is a block diagram showing the GPRS-based wireless data transmission functions of the WAIN in accordance with the invention.

FIG. 7 is a block diagram showing how WAINs exchange data with each other and other GPRS networks in accordance with the invention.

FIG. 8 is a flowchart detailing the basic operations of the WAIN in accordance with the invention.

FIG. 9 is a flowchart detailing the system configuration of the WAIN in accordance with the invention.

FIG. 10 is a flowchart detailing downlink data processing performed by the WAIN in accordance with the invention.

FIG. 11 is a flowchart detailing the radio link process in downlink data processing performed by the WAIN in accordance with the invention.

FIG. 12 is a flowchart detailing uplink data processing performed by the WAIN in accordance with the invention.

FIG. 13 is a flowchart detailing the radio link process in uplink data processing performed by the WAIN in accordance with the invention.

FIG. 14 is a diagram showing how WAINs may be clustered to provide service in a community service area located within cells of a public network in accordance with the invention.

FIG. 15(a) is a flowchart detailing the temporary MEI registration of mobile units in a WAIN system in accordance with the invention.

FIG. 15(b) is a flowchart detailing the Attach procedure supporting the temporary MSI registration of mobile units in a WAIN system in accordance with the invention.

FIG. 15(c) is a flow chart detailing the cancellation of the temporary MEI/MSI registration for mobile units in a WAIN system in accordance with the invention.

FIG. 16 is a block diagram showing the customized services which may be provided by a WAIN in accordance with the invention.

### DETAILED DESCRIPTION

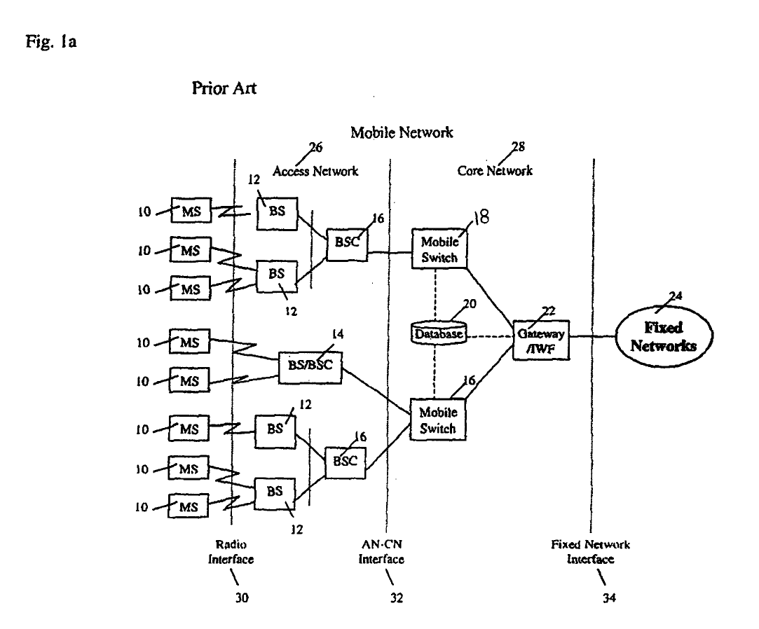

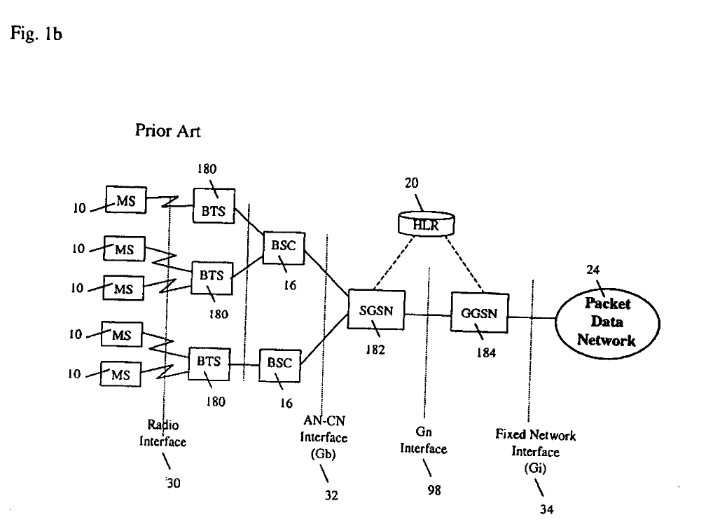

With reference to FIG. 1, in a 3G mobile system, mobile stations (MS) 10 are either connected to a base station (BS) 12, which is in turn connected to a base station controller (BSC) 16, or a combination base station/base station controller (BS/BSC) 14. The BSC 16 or BS/BSC 14 is connected to a mobile switch (generally known as the Mobile Switching Center (MSC)) 18 for either circuit- or packet-switching. The Mobile Switch 18 is also responsible for the mobility management of MSs 10 attached to the network. A database 20 (often referred to as a Home Location Register (HLR)) linked to the Mobile Switch 18 stores the MSs' 10 subscription and operational data. Several Mobile Switches 18 may be connected to a gateway (generally known as the gateway mobile switch center (GMSC)) or interworking function (IWF) 22 which interworks with fixed networks 24 (such as a PDN).

The BSs 12 and BSCs 16 or BS/BSCs 14 form the Access Network 26, where user traffic enters the mobile communications network. The mobile switch 18, database 20, and gateway/IWF 22 form the Core Network 28 where data packets and messages are routed to other networks. Each network node deals with different functions and communicates with the other nodes through a defined interface. For instance, MSs 10 enter the Access Network 26 via the radio interface 30. Operations at the radio interface 30 may include channel access, error correction, multiplexing, modulation, and radio transmission. The BSC 16 or BS/BSC 14 connect with mobile switch 18 via the access network-core network (AN-CN) interface 32. The gateway/IWF 22 connects to fixed networks 24 via the fixed network interface 34. Operations here may include converting transmission speeds, protocols, codes, etc.

As shown in FIG. 1b, the terminology for a GPRS-based mobile data network differs slightly from the mobile network depicted in FIG. 1a. Here MSs 10 are linked by a radio interface 30 to a Base Transceiver Station (BTS) 180 (the equivalent of the BS in FIG. 1a) which in turn connects with a BSC 16. The BSC 16 connects to a mobile switch known as a Serving GPRS Support Node (SGSN) 182 via an interface 32. SGSN 182 is also connected to the Gateway GPRS Support Node (GGSN) 184 (the equivalent of the gateway in FIG. 1a) via a switch-gateway interface 98. The GGSN 184 is logically connected to the packet data network 24 via a packet data network interface 34. The database, or HLR, 20 is connected to the SGSN 182 and GGSN 184.

The current mobile networks have inherited a hierarchical architecture in which multiple network nodes communicate to each other to support data transferred through the network. In the multi-node wireless network architecture, each network node deals with different functions and communicates with each other through a defined interface. In standard mobile data networks, the data transmission and signaling exchange protocols on all interfaces are specified using the concepts of the reference model of Open System Interconnection (OSI). Communication between peer entities at the same layer but at different nodes across an interface are achieved through a defined protocol and associated functions for that layer. The functions at each layer can evolve independently of other layers. The layered protocol structure employed eases the implementation of the complex system and allows the flexibility for future enhancements. The exchange of information between two peer entities is performed according to the corresponding layer protocols. The information is logically exchanged between peer entities by messages, or Protocol Data Units (PDUs). The physical information flow for achieving the peer-to-peer communication is actually through the service primitives between adjacent layers at the same node and via the physical medium (maybe a radio link) between two nodes.

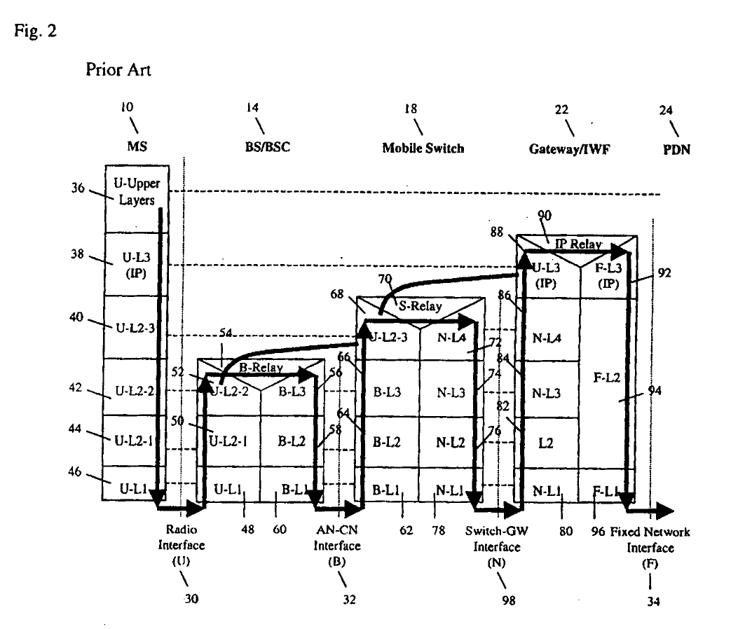

With reference to FIG. 2, the mobile data network can be seen as a bearer for transferring the IP packets from the MS 10 across multiple interfaces to an external packet data network 24. The protocol structure of the mobile data network is as follows. Logically, the MS 10 communicates with multiple network nodes. In particular, the lower three layers U-L1 46, U-L2-1 44 and U-L2-2 42 communicate with the peer layers at the BS/BSC 14, the U-L2-3 40 layer with the mobile switch 18, the U-L3 (IP) 38 layer with the Gateway/IWF 22. The layers U-L2-1 44 through U-L2-3 40 below the network layer U-L3 38 are equivalent to layer 2 in the OSI reference model.

A layer 3 PDU, or an IP packet initiated from the MS 10 is sent from the network layer U-L3 38 or IP layer to the underlying layer U-L2-3 40, and then in turn to U-L2-2 42, U-L2-1 44 and the physical layer (or layer 1) U-L1 46 at the MS 10. Each layer includes the upper layer packet data unit (PDU) as payload in its own PDU and adds necessary control information (headers and trailers) so that the peer layer knows how to handle the PDU and recover the payload.

The PDU from layer 1 U-L1 46 at the MS 10 is passed to the layer 1 U-L1 48 at the BS/BSC 14 through a radio link across the radio interface (U) 30. The U-L1 48 at the BS/BSC 14 will perform the required actions requested by sender's control information and recover the payload and pass to its upper layer U-L2-1 50 and then U-L2-2 52. After the payload of U-L2-2 42 (or the U-L2-3 40 PDU) is recovered by the layer U-L2-2 52 at the BS/BSC 14, it will be relayed 54 to the protocol stack at the BS/BSC 14 for the AN-CN interface (B) 32.

The PDU will be passed downward to B-L3 56, B-L2 58 and B-L1 60 at the BS/BSC 14 in the same way a U-L3 38 PDU (IP packet) is passed to U-L1 46 at the MS 10. Then the B-Ll 60 PDU will be transferred across the AN-CN interface 32 to the B-L1 62 at the mobile switch 18.

The payload of the PDU in each layer will be recovered and submitted to a higher layer in the Mobile Switch 18 in the same way as in BS/BSC 14 for a PDU traveling upward. This downward-medium crossing-upward-relay process (indicated using an arrow path) continues until the IP packet is recovered and sent to the U-L3 (IP) layer 88 at the Gateway/IWF 22. This layer is a peer layer of U-L3 (IP) 38 at the MS 10. The recovered IP packet originating from MS 10 is relayed and sent to the external PDN 24 across the packet data network interface (F) 34. IP packets sent from the PDN 24 will follow a reverse path and be recovered at the U-L3 (IP) 38 layer at the MS 10.

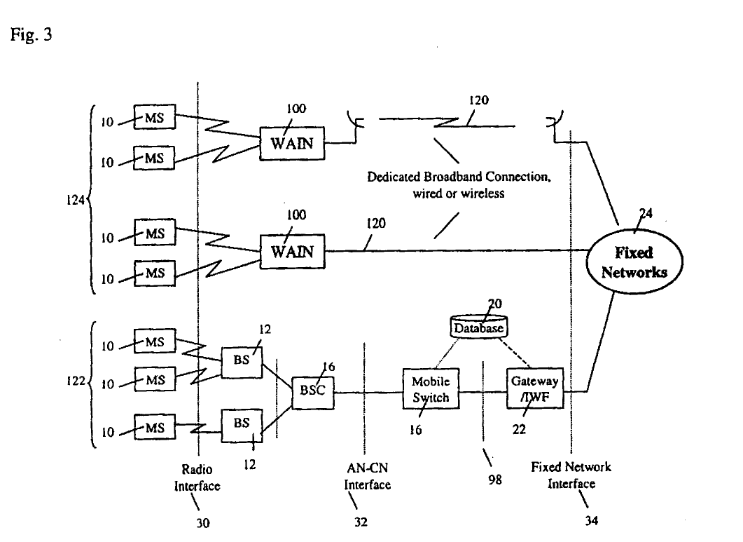

With reference to FIG. 3, a wireless access integrated node (WAIN) 100 allows mobile users data to travel through the WAIN 100 directly to the packet data network 24 instead of competing for resources for wireless data access through the BS-BSC-Switch-Gateway 12-16-18-22 chain in the public mobile data network 122. In the WAIN system 124, data is sent from an MS 10 to the WAIN 100 and then to the packet data network 24 (or Internet) via a dedicated broadband connection 120. In this system 124, the AN-CN interface 32 and the Switch-GW interface 98 in the public mobile data network 122 are eliminated.

In FIG. 2, the layers B-L1 60, 62 through B-L3 56, 66 are responsible for transferring the U-L2-3 40, 68 PDUs across the AN-CN interface (B) 32. These layers do not contribute to the overall end-to-end data transfer. Once the B interface 32 collapses in the WAIN 100, these protocol layers do not need to be implemented.

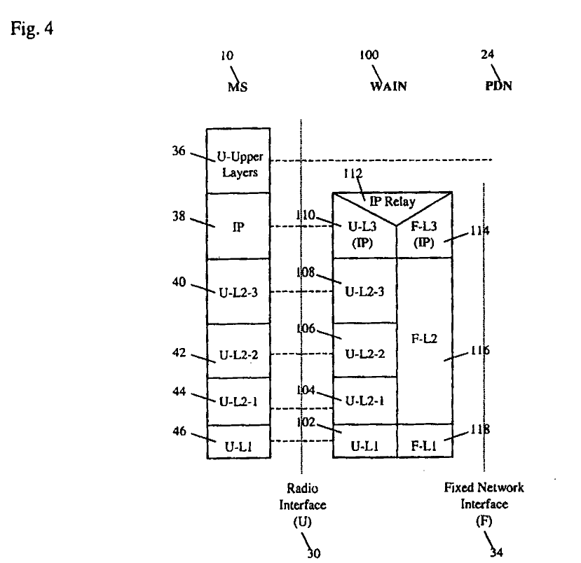

Referring to FIG. 2 and FIG. 4, the layer U-L2-3 68 specified at the standard mobile switch 18 can be directly on top of the layer U-L2-2 52 specified at the standard BS/BSC 14. Likewise, the protocol layers across the N interface 98 can also be eliminated. With the unnecessary protocol layers (shown in shaded areas in FIG. 2) removed, the simplified protocol structure for the WAIN is shown in FIG. 4. A comparison of the protocol structure of the WAIN in FIG. 4 with the protocol structure shown in FIG. 2 in the standard multi-node mobile data networks shows the protocol functions required in the WAIN system have been reduced. This protocol simplification can apply to current or future mobile data networks, either TDMA based or CDMA based.

In FIG. 4, data, in the form of a PDU, is passed from MS 10 from the IP layer 38 through layers U-L2-3 40, U-L2-2 42, U-L2-1 44 and U-L1 46. Each of these layers adds control information (data packet headers and trailers) so the peer layer at other nodes will know how to handle the PDU. The PDU at layer U-L1 46 of MS 10 is passed via the radio interface 30 to layer U-L1 102 in the WAIN 100. The PDU is then passed up through protocol layers U-L2-1 104, U-L2-2 106, and U-L2-3 108 and processed accordingly. The PDU is then passed to IP layer, U-L3 110. The PDU is then relayed 112 to the WAIN's protocol stack for the packet data network interface 34. Here, the PDU travels from the IP layer F-L3 114 to the second layer F-L2 116 and finally to the physical layer F-L1 118 where it is passed to the packet data network 24.

The removal of these unnecessary protocol stacks reduces transmission delay. This is particularly important in delay-sensitive applications such as Voice over IP. This simplified architecture also greatly reduces the cost of providing access to wireless data services.

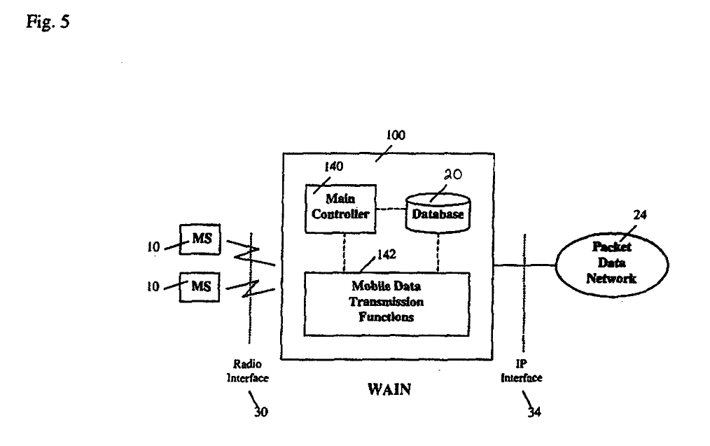

With reference to FIG. 5, this generalized version of the WAIN 100 can support IP data transfer between MSs 10 and packet data networks 24 such as the Internet. The WAIN's 100 main controller 140 oversees the mobile data transmission functions 142. A database 20 stores the MSs' 10 subscription and operational data.

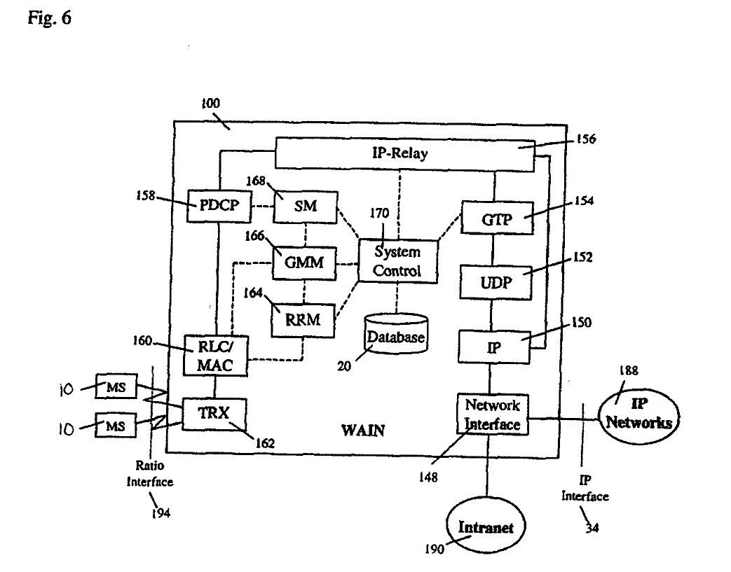

In FIG. 6, the WAIN system supports functions of GPRS network nodes BTS/BSC/SGSN/GGSN (the prior art configuration of this network is shown in FIG. 1b) while eliminating intermediate interfaces between these nodes. The WAIN 100 communicates with GPRS-enabled mobiles 10 via the GPRS radio interface 194, is able to handle packet traffic, and interworks with external IP networks 188 through a standard IP interface 34. Although connection to IP networks 188 is discussed here, the WAIN 100 can also connect to a non-IP packet data network (PDN). The GPRS supports the TDMA radio access technology in GSM/EDGE and TIA/EIA-136 and CDMA radio access technology in UMTS.

To transmit information to the MS 10, an IP packet sent from the IP network 188 is received by network interface 148 and processed by the IP layer 150. The IP relay 156 then sends the PDU to a Packet Data Convergence Protocol (PDCP) module 158 for multiplexing and compression to improve transmission efficiency. The PDU is then sent to the Radio Link Control (RLC)/Medium Access Control (MAC) module 160 which controls the logical link and provides acknowledge/unacknowledged data transfer for supporting requested quality of service. MAC handles the radio medium access and ensures there is no collision of access requests. RLC 160 handles segmentation, sequence control, encryption, backward error correction, data multiplexing, and radio access control of multiple mobiles sharing the radio resource. The ciphered radio block is sent by the RLC/MAC module 160 to a Transceiver (TRX) module 162. The GPRS TRX 162 supports forward error correction and interleaving, physical channel multiplexing, modulation, equalization (in TDMA radio) or spreading (in CDMA radio), and RF transmission and physical link control across the radio interface 194.

Signaling functions are also implemented in the WAIN 100. The Radio Resource Management (RRM) module 164 controls radio resource assignment. The GPRS Mobility Management (GMM) module 166 controls mobility and security and the Session Management (SM) module 168 controls packet data transfer and routing.

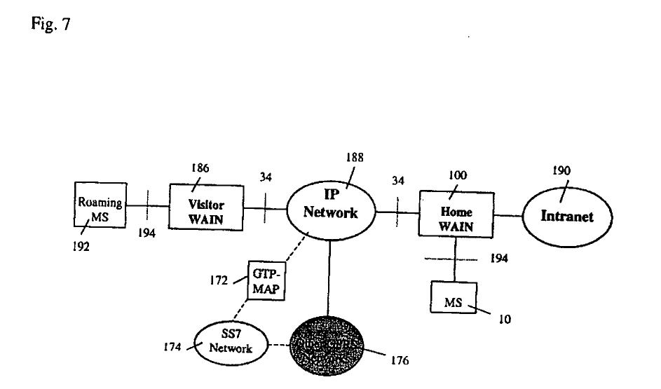

To transmit information from the MS 10, a PDU is passed over the radio interface 194 to the WAIN's 100 TRX module 162. The PDU is then sent to the RLC/MAC module 160 and the PDCP module 158. The PDU then goes to the IP Relay 156 and is processed by the IP layer 150. (The GTP 154 and UDP modules 152 are employed for communication with other WAINs or other GPRS networks for data transfer and associated signaling. See FIG. 7.) The PDU goes to the network interface module 148 and is sent to the IP network 188 via the IP interface 34.

With reference to FIGS. 4 and 6, the protocol structure for a GPRS-based mobile network is as follows. Layer U-L2-1 104 corresponds to MAC 160, U-L2-2 166 is RLC 160, and U-L2-3 106 is PDCP 158. The signaling functions SM 168, GMM 166, and RRM 164 also correspond to U-L2-3 106.

Referring again to FIG. 6, the WAIN 100 also contains a system control module 170 as well as a database 20. The system control module 170 is a central control entity which manages the other modules, coordinates GPRS signaling and data and transfer, and collects charging data. The database 20 stores the mobile subscription information and mobility/session/charging data.

With reference to FIG. 7, the WAIN 100 can communicate with other WAINs 186 by tunneling through external IP networks 188 to support an MS's 10 ability to roam between other WAIN systems 186. When an MS 192 roams to an area covered by a visitor WAIN 186, its home WAIN 100 can be determined through interrogation between WAINs 100, 186. The roaming MS 192 may want to access a network (e.g. an Intranet 190) that is only connected to the home WAIN 100. In this case, an IP packet from the roamed MS 192 will be sent through a GPRS Tunneling Protocol (GTP) over UDP/IP (see FIG. 6), which tunnels the packet through the IP network 188 to the home WAIN system 100. No new interface is required for interworking between WAINs 100, 186. The same radio interface 194 between roaming MS 192 and WAIN 186 and the same IP interface 34 between the WAINs 100, 186 and the IP network 188 which were employed in FIG. 6 may be used.

Roaming between a WAIN 100 and a public GPRS network 176 is also possible. In current mobile networks, database interrogation (for subscription and charging information, etc.) is done through a Signaling System No. 7 (SS7) network 174 that is based on Mobile Application Part (MAP). WAIN systems do not need to use a MAP-based SS7 network 174 to transfer data or interrogate database information when the systems are interconnected and communicating with each other. However, for roaming between a WAIN 100 and a public GPRS network 176 containing standard nodes SGSN, GGSN and HLR (see FIG. 1b), a GTP-MAP conversion 172 is needed.

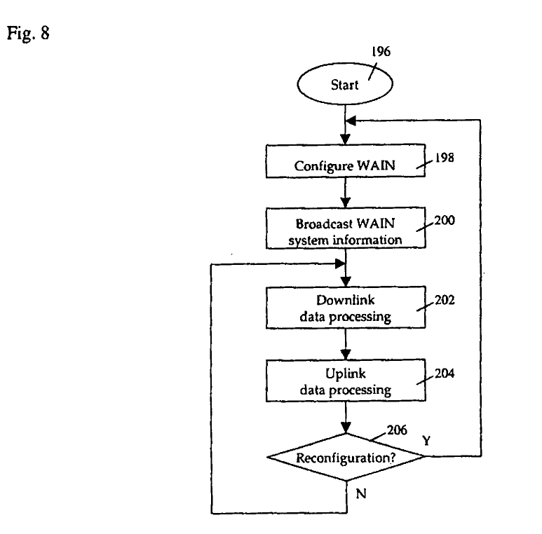

As shown in FIG. 8, after power up (step 196), the WAIN may automatically configure itself (step 198) for optimal performance by selecting a set of system parameters. These system parameters include carrier frequency, spreading code for CDMA systems, Cell ID, Routing Area ID, transmission power level, etc. Once it is configured, the WAIN will generate a set of system information messages to be broadcast to all mobiles (step 200). These messages provide information about the WAIN coverage area identification as well information about the channel structure, radio access, and paging parameters in the area. The process control then goes into a loop of processing downlink (the data link from the BS 12 to the MSs 10) (step 202) and uplink (the data link from the MSs 10 to the BS 12) data (step 204). At the end of the loop, a check is performed on whether a reconfiguration request has been received (step 206). If a reconfiguration is needed, the process control will go back and reconfigure the WAIN (step 198). If reconfiguration is not requested, the loop of processing downlink (step 202) and uplink data (step 204) continues.

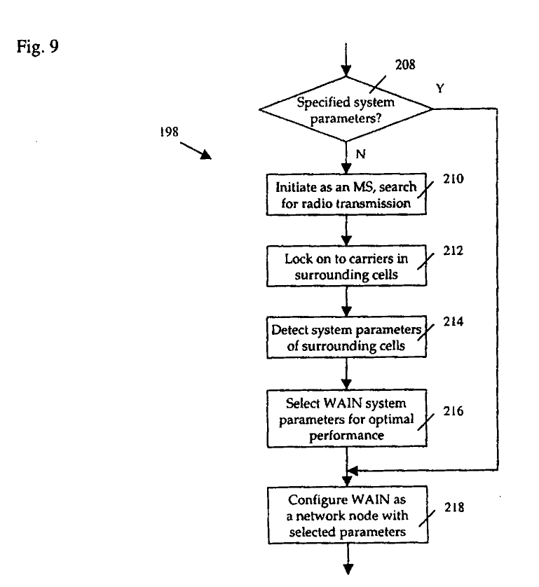

With reference to FIG. 9, the configuration process (step 198) can be accomplished using a set of system parameters. If the system is given specified system parameters (step 208), the WAIN will be configured as a network node with the specified system parameters (step 218). However, if there are no specified system parameters (step 208), the WAIN will first initialize itself as an MS (step 210).

As shown in FIG. 4, the radio interface protocols in the WAIN are similar to those at the MS except for some asymmetric communications procedures. Therefore, once installed in a local confined area, the WAIN system will initialize itself as an MS (step 210) and will search for the radio transmission from broadcast channel (or pilot channel) carriers in the surrounding cells. It will then lock onto the carriers (probably the ones with the strongest signal strength) (step 212) and decode the system parameters used in that cell (step 214). After the system parameters of the surrounding cells have been detected, a set of distinct system parameters is selected to minimize the interference between WAIN systems or between the WAIN and other cells (step 216). These parameters will be used to configure the WAIN as a network node communicating with mobiles (step 218).

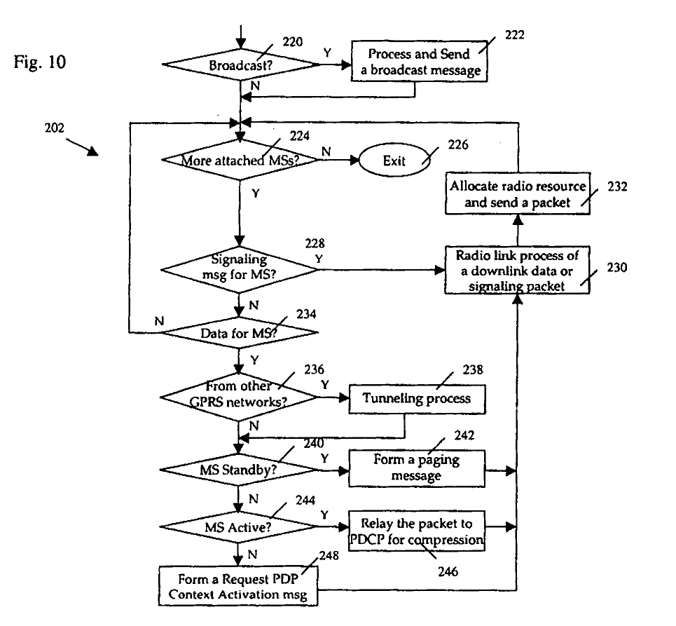

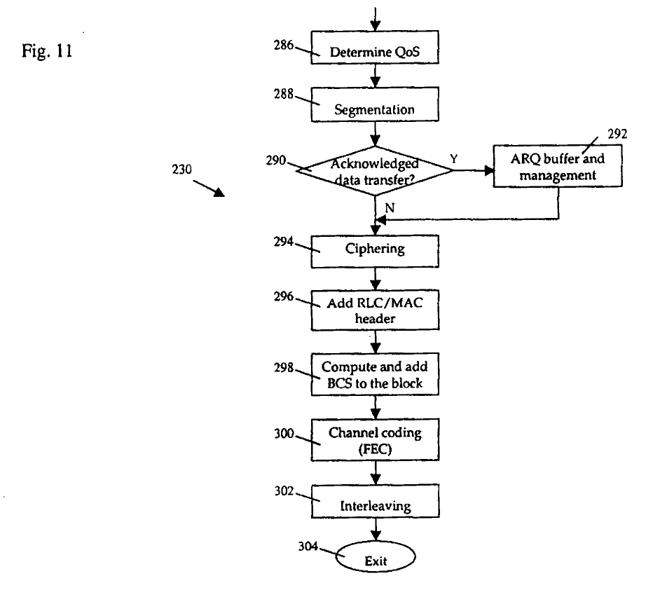

In FIG. 10, downlink data processing (step 202 in FIG. 8) in the WAIN begins by first checking to see if there is a broadcast information message scheduled to be sent (step 220). If there is, the message is processed and sent (step 222). After the broadcast message is processed and sent (step 222), or if there was no broadcast message to be sent, the WAIN enters a loop to process downlink data for each attached MS (step 224). If there is a signaling message to be transmitted to the MS (step 228), the message is sent to a radio link processing module for segmentation, ciphering and channel coding (step 230) (see FIG. 11). A radio resource is then allocated and the packet is sent (step 232). If there is no signaling message to be sent, the WAIN checks if there is a data packet for the MS (step 234). If there is no data packet for the MS, the process control will go back to check for more attached MSs (step 224). However, if there is a data packet for the MS, a determination must be made whether it is directly from an IP network or other GPRS networks tunneling through the IP network (step 236). If it is from another GPRS network, the GTP tunneling header will need to be processed before recovering the IP packet for the MS (step 238). In order to receive the packet, the attached MS has to be in a GMM Ready state (controlled by a Ready timer) and Packet Data Protocol (PDP) Active state. If the MS is not Ready but in GMM Standby state (step 240), a paging message needs to be formed (step 242) and sent to the mobile (steps 230, 232). A determination also needs to be made of whether the MS is Active (step 244). If the MS is Ready but not Active, a Request PDP Context Activation message needs to be formed (step 248) and sent to the mobile (steps 230, 232). If the MS is both Ready and Active, the data packet will be relayed to the PDCP module for compression (step 246). Once a data or signaling packet is segmented, ciphered, and channel coded, it should be modulated and sent over the available radio block (step 230) (see FIG. 11). If the radio block is not allocated, a resource allocation procedure needs to be initiated (step 232). The loop is exited only after all attached MSs have been checked (step 226).

In FIG. 11, the radio link process (step 230) begins with a determination of Quality of Service based on the request from the SM/GMM or PDCP module (step 286). If the packet is too long for the underlying radio module to process, the packet is segmented (step 288). If the packet is to be sent in an acknowledged mode (step 290), a buffer of transmitted data should be maintained for Automatic Retransmission (ARQ) (step 292). The packet is ciphered using a GPRS ciphering algorithm and a secret ciphering key to provide security (step 294). The RLC/MAC header information is generated and added to the block (step 296); a Block Check Sequence (BCS) is also generated and added (step 298). The radio block is then channel coded for Forward Error Correction (FEC) (step 300). The data is interleaved to provide additional protection (step 302). Once the above steps have been completed, the radio link process is completed and the module is exited (step 304).

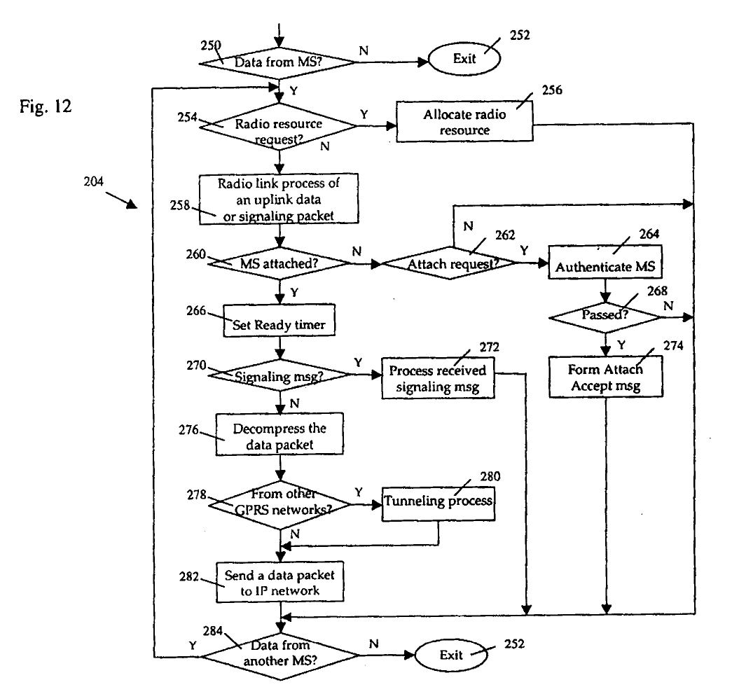

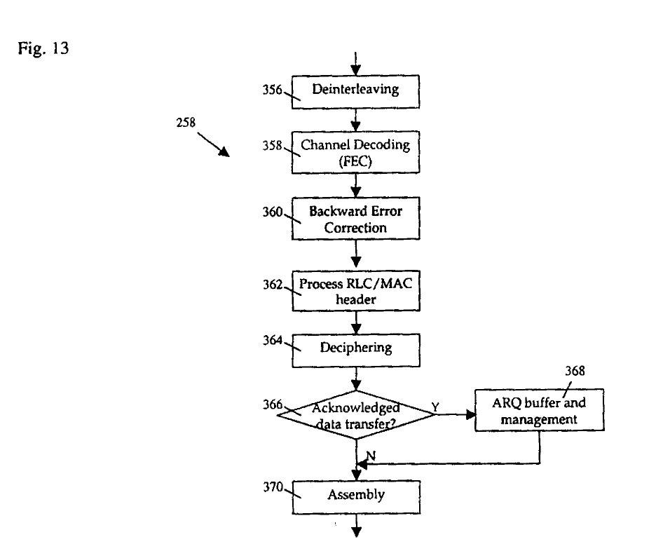

With reference to FIG. 12, uplink data processing (step 204 in FIG. 8) begins by determining whether data is received from any MS (step 250). If no data has been received, the process stops (step 252). If there is a radio resource request from an MS (step 254), the WAIN will initiate a resource allocation procedure (step 256). If there is no radio resource request, the data or signaling packet is received and the data processing—decoding, deciphering, and reassembling—begins (step 258 (see FIG. 13)). If the packet is determined to be from an unattached MS (step 260) and there is an Attach Request message (step 262), the WAIN will get the MS identity and authenticate the MS (step 264). If the MS is validated (step 268), the WAIN will generate an Attach Accept message to acknowledge the MS (step 274).

If the MS is attached (step 260), then the WAIN moves to the GMM Ready state and the Ready timer starts (step 266). If the packet is a signaling message (step 270), the message is processed (step 272). Otherwise, the received data packet is decompressed in the PDCP module (step 276). The WAIN then determines whether to send the recovered IP packet directly to an IP network or to another GPRS network tunneling through the IP network (step 278). If tunneling is required, the GTP header needs to be added to the data unit (step 280) before sending the packet to the IP network (step 282). If no tunneling is required, the packet is sent directly to the IP network (step 282). After an IP packet is sent out to the IP network (step 282), the WAIN checks whether data has been received from another MS (step 284). If data has been received from another MS, the process control goes to the top of the loop and determines the type of data received (step 254). If no more data has been received, the process control exits the loop (step 252).

In FIG. 13, the radio link process of an uplink data or signaling packet (step 258 in FIG. 12) begins by deinterleaving the packet (step 356). The received data is channel decoded for forward error correction (FEC) (step 358) and backward error correction (step 360). The RLC/MAC header is then processed (step 362) and the information is deciphered (step 364). If the data is acknowledged (step 366), the ARQ buffer needs to updated and a retransmission initiated if necessary (step 368). Once the buffer has been updated (step 368), or if the data transfer is not acknowledged (step 366), the data is reassembled to recover the IP packet before sending it to the PDN (step 370).

The WAIN presented in this invention can be locally owned to provide mobile data services to the mobile users in a local confined area. This can be owned and operated by a business or a home owner. The data packets from the mobile terminal in the WAIN environment will be routed through the WAIN system and the local data connection to the PDN. No radio and network resources from the public mobile network are used. As a result, these calls may incur no or a minimal air charge. This localized charging scheme can be implemented by the local owners to meet the business needs.

The WAIN system also supports the wireless data services in a community. A community service area is an area that encompasses one or more WAIN service areas that have a defined roaming agreement with each other. This service area is specially defined for providing wireless data services to business locations or residential areas that expand to multiple buildings and complexes.

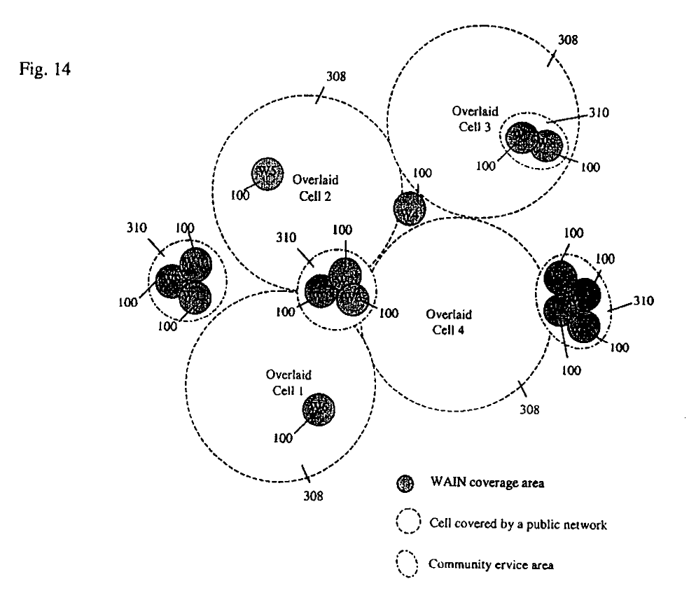

In FIG. 14, WAIN systems 100 are installed as a cluster to provide services within cells 308 covered by a public network. These clusters of WAINs 100 can provide reliable services in a confined community areas 310 that are either larger than what one WAIN system 100 can cover or require a capacity higher than what a WAIN system 100 can provide.

For a community service area supported by multiple WAIN systems, the WAIN systems are interconnected through a local data network and they are owned and operated by the same WAIN operator in the community. Roaming is supported between the individual WAIN areas within this community. When a mobile moves out of one WAIN service area, the associated WAIN system will coordinate with neighboring WAIN systems to ensure the continuous and reliable services within the community service area. This will be taken care of by the standard mobility management functions. In the case of serving a community area with a cluster of WAINs, the system configuration and re-configuration should be well coordinated to obtain an optimal system configuration for all the WAIN systems in the cluster.

Data transmission for high bit rate multimedia services is extremely sensitive to noise. These services also require more radio resources, such as more time slots in the case of TDMA or more code channels in case of CDMA. Due to the multipath interference and lack of radio resources in the public mobile networks, providing multimedia services to massive users is not feasible. While compatible with the public mobile network, the WAIN system provides more reliable radio coverage in the small confined area. In the WAIN environment, the user will most likely complete a mobile data transmission transaction within the original coverage area. Due to the very low mobility within a WAIN system, the multipath interference will be minimized. Furthermore, in the small local WAIN environment where the service requests can be better coordinated, it is possible for one user to use more radio resources on a radio channel or even use the entire radio channel. Therefore, high data rate wireless multimedia services are feasible.

Before a new mobile terminal can be used in the local WAIN environment, it needs to be registered with the WAIN system that is configured to support the same radio access technology the mobile supports. A permanent subscription for the mobile user in the community can be obtained from the WAIN operator in the community area in a way similar to the standard subscription procedure. In addition, temporary subscription profiles can be created in the database, for instance for customers checked into a hotel or registered at a conference which features a WAIN. Once the users leave the hotel or conference, the service registration can be canceled from the database.

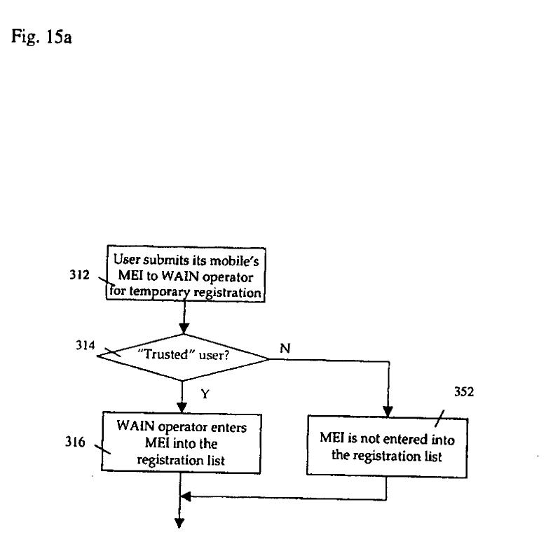

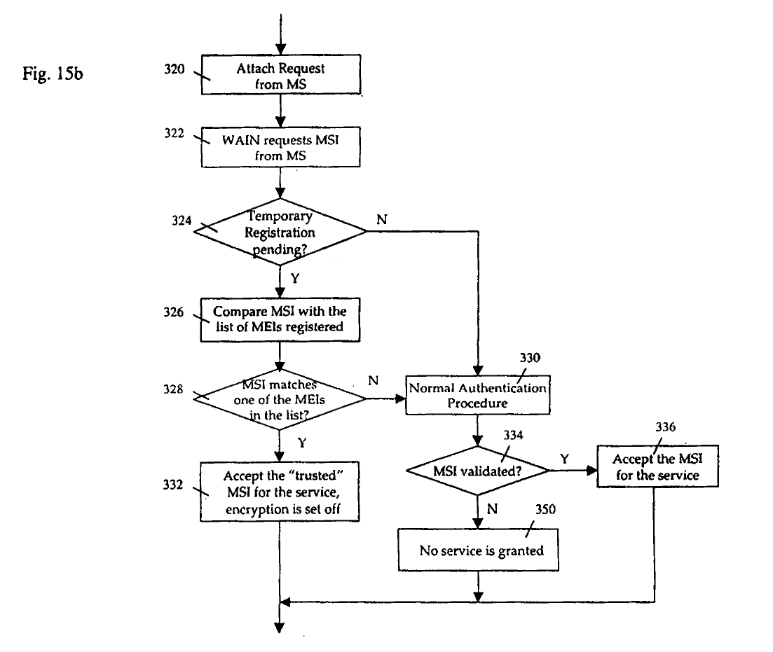

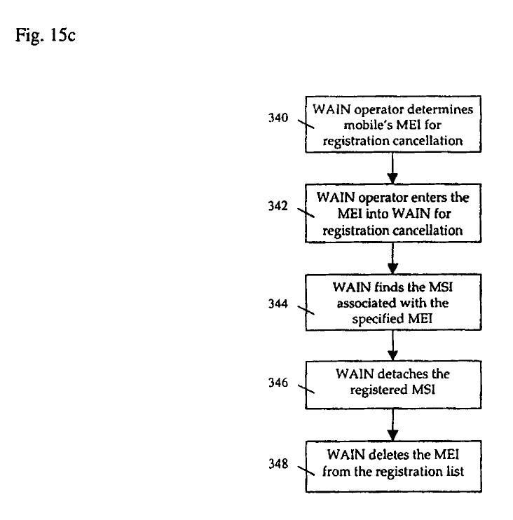

The mobile's unique secret Mobile Subscriber Identity (MSI) is obtained through a permanent subscription and used in a standard authentication procedure for validation which is known in the prior art. In FIG. 15(a), a new user may submit to the WAIN operator the mobile terminal's unique Mobile Equipment Identity (MEI) which is known to the user (step 312) in order to obtain WAIN services on a temporary basis. Then the operator verifies if the user can be accepted as a “trusted” user (step 314). If the user is accepted by the WAIN operator as a “trusted” user (such as a hotel guest), then its MEI is entered into a registration list by the WAIN operator (step 316). If the user is not accepted as a trusted user, the MEI is not entered into the registration list (step 352) which is contained in the WAIN's database. Once the MEI is entered into the registration list, the user may turn on the mobile and try to attach to the WAIN.

In the Attach procedure as shown in FIG. 15(b), when an Attach request message is received by the WAIN (step 320), the WAIN will always request its MSI (step 322). The WAIN will check if there is a temporary registration request pending (step 324). If a request is pending, the received MSI is compared with the list of registered MEIs (step 326). A check is performed to see if the MSI matches any MEI in the registration list (step 328). If it matches one of the registered MEIs, then this MSI will be accepted as a “trusted” user for the WAIN services (step 332). Since no security key information is available at the WAIN for the mobile in the temporary registration process, no encryption can be performed on messages sent to or by the temporarily registered mobile. If the MSI doesn't match any of the registered MEIs, or if there is no MEI registered, the received MSI will be used in the standard authentication procedure (step 330) and a check is performed to see if the MSI passes the validation test (step 334). If it passes the test, the service attach request is granted (step 336). If it fails the test, no service is granted (step 350).

Once the registered user no longer needs the WAIN service, the WAIN operator can cancel the registration based on the MEI as shown in FIG. 15(c). To cancel the temporary registration, the WAIN operator first determines mobile's MEI for the registration cancellation (step 340) and then enters the MEI into the WAIN for registration cancellation (step 342). The WAIN finds the MSI that is associated with the specified MEI (step 344). WAIN will then detach the registered MSI (step 346) and delete the MEI from the registration list (348).

For some applications, such as WAIN systems installed in a hotel or a conference, the WAIN operator may make available for hotel guests or conference attendees a number of pre-subscribed phones that can work with the WAIN system. The MSI, security key information and service features of these phones are pre-registered in the WAIN's database by the WAIN operator. Therefore, full security functions including automatic authentication and encryption can be performed when these phones are used in the WAIN environment.

The locally installed distributed WAIN system is easily accessible to and may be operated by a business owner. It can be connected to the business's Intranet and allows the mobile users to access an attached content server for receiving value-added services provided by the business owner. The WAIN can also be connected to a stand alone Local Information System to allow mobile users to retrieve information from or report data to the information system through the WAIN system. Remote data sensors can be used to collect data and transmit the data to the Local Information System through the WAIN.

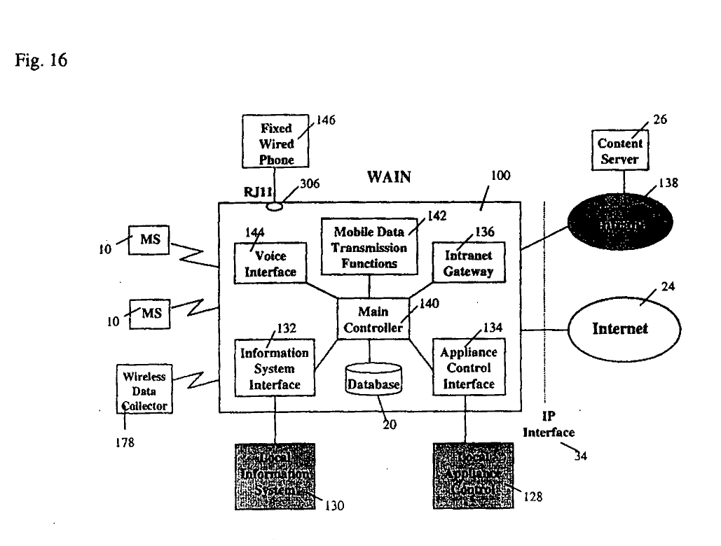

FIG. 16 shows a WAIN system supporting IP data transfer to an Intranet 138 as well as a packet data network 24 such as the Internet. IP data may be transferred via an Intranet gateway 136 to an Intranet 138 featuring a content server 126 that may provide value-added services to mobile users of the WAIN system 100. The WAIN 100 also supports remote control, via an appliance control interface 134, of a local appliance control system 128. The Information System Interface 132 in the WAIN 100 provides a link to the Local Information example, a wireless Personal Digital Assistant (PDA) can be remotely synchronized with its host program on the Local Information System through the WAIN. The appliance control interface 134 in the WAIN 100 communicates with the Local Appliance Control System 128 and forwards the commands or reports to or from the system 128 for appliance control and monitoring. The WAIN 100 can receive and send data to MSs 10, a fixed wire telephone 146, via an RJ11 port 306, and a wireless data collector 178.

A locally installed WAIN system 100 may also include a voice interface subsystem 144 to support voice-recognition and text-to-speech synthesis, which are known in the prior art. The mobile users' 10 vocal requests/commands can be received and converted to text messages through a voice recognition system. The converted requests/commands will be sent to the Local Information System 130 to retrieve the information. Data retrieved for, or the appliance status reported to the mobile users can be converted to a voice form through the text-to-speech synthesizer and delivered to the mobile users 100. As noted above, the WAIN system 100 may also have an RJ11 port 306 for supporting a fixed wired telephone 146.

All the customized services provided by the WAIN 100 are controlled by the WAIN's main controller 140. The main controller 140 also controls the mobile data transmission functions 142. Subscription information and charging data is contained in a database 20.

Although the preceding description of the invention has discussed the licensed frequency bands allocated in the standard mobile networks, the WAIN system described in this invention applies also to the unlicensed frequency bands. The WAIN may operate in the 450 MHz, 900 MHz 1800 MHz, and 1900 MHz bands for GSM systems in different regions. When used in TIA/EIA-136 TIA/EIA-95 systems, the WAIN will operate in the 800 band; for UMTS and cdma2000 standards, the WAIN will ate at 1900 MHz. The WAIN will also operate in the MHz, 2.4 GMHz, and 5.7 GHz unlicensed bands.

1-74. (canceled)

75. In a communications network, a method for configuring a wireless access integrated node as a network node where no specified system parameters are present, said method comprising:
a) initializing a wireless access integrated node as a mobile station;
b) searching for radio transmission from broadcast control channel carriers in surrounding cells;
c) locking on to each of said carriers;
d) detecting and decoding system parameters used in surrounding cells;
e) selecting a set of system parameters to minimize interference between a plurality of wireless access integrated nodes or between a plurality of wireless access integrated nodes or between a wireless access integrated node and other cells; and
f) configuring said wireless access integrated node as a network node using said set of system parameters; wherein the initializing, searching, locking, detecting, selecting, and configuring steps are performed by the wireless access integrated node.

76. The method of claim 75 wherein a system parameter is carrier frequency.

77. The method of claim 75 wherein a system parameter is spreading code for CDMA systems.

78. The method of claim 75 wherein a system parameter is Cell ID.

79. The method of claim 75 wherein a system parameter is Routing Area ID.

80. The method of claim 75 wherein a system parameter is transmission power level.

81. A machine-readable medium having stored thereon data representing sets of instructions which, when executed by a machine, cause the machine to configure a wireless access integrated node as a network node where no specified system parameters are present, the sets of instructions further causing the machine to:
a. initialize a wireless access integrated node as a mobile station;
b. search for radio transmission from broadcast control channel carriers in surrounding cells;
c. lock on to each of said carriers;
d. detect and decode system parameters used in surrounding cells;
e. select a set of system parameters to minimize interference between a plurality of wireless access integrated nodes or between a plurality of wireless access integrated nodes or between a wireless access integrated node and other cells; and
f. configure said wireless access integrated node as a network node using said set of system parameters; wherein the initializing, searching, locking, detecting, selecting, and configuring steps are performed by the wireless access integrated node.

81. The machine-readable medium of claim 81, wherein a system parameter comprises carrier frequency.

83. The machine-readable medium of claim 81, wherein a system parameter comprises spreading code for CDMA systems.

84. The machine-readable medium of claim 81, wherein a system parameter comprises Cell ID.

85. The machine-readable medium of claim 81, wherein a system parameter comprises Routing Area ID.

86. The machine-readable medium of claim 81, wherein a system parameter comprises transmission power level.
